(19) United States
(12) Patent Application Publication
(10) Pub. No.: US 2011/0003630 A1
(43) Pub. Date: Jan. 6, 2011

(54) GAMING MACHINE ELECTROPHORETIC APPARATUS, SYSTEMS, AND METHODS

(75) Inventors: James M. Rasmussen, Chicago, IL (US); Peter R. Anderson, Glenview, IL (US); Timothy C. Loose, Chicago, IL (US); Gene Rigsby, Chicago, IL (US); Richard T. Schwartz, Chicago, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc.

(21) Appl. No.: 12/882,766

(22) Filed: Sep. 15, 2010

Related U.S. Application Data
(62) Division of application No. 11/570,531, filed on Dec. 5, 2007.
(60) Provisional application No. 60/606,381, filed on Sep. 1, 2004.

(51) Int. Cl. A63F 13/00

(52) U.S. Cl. 463/20; 463/30

(57) ABSTRACT

Apparatus, system, and methods may include a value input device for receiving a wager, a housing attached to the value input device, at least one rotatable reel attached to the housing, the reel comprising a reel strip arranged about a periphery of a cage, and a controller attached to the housing and operatively coupled to an input device to alter appearance of a first part of an electrophoretic image display attached to at least one of a player tracking card or a credit ticket that can be read by the input device. Additional apparatus, systems, and methods are disclosed.

### RELATED APPLICATIONS

This application is a continuation of U.S. patent application Ser. No. 11/570,531, filed Dec. 5, 2007, which is a U.S. National Stage Filing under 35 U.S.C. 371 from International Patent Application Ser. No. PCT/US2005/029919, filed Aug. 24, 2005, and published on Mar. 16, 2006 as WO 2006/028699 A2 and republished as WO 2006/028699 A3, which claims the priority benefit under 35 U.S.C. 119 (e) of U.S. Provisional Application Ser. No. 60/606,381, filed Sep. 1, 2004, all of which are incorporated herein by reference in their entireties.

This application may be related to U.S. patent application Ser. No. 11/275,155, filed Dec. 15, 2005, entitled “GAMING MACHINE HAVING ELECTROPHORETIC DISPLAYS AND METHOD THEREOF.”

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the example code, screen shots, and images described below, and in any drawings appended hereto: Copyright 2010 WMS Gaming Inc. of Waukegan, Ill. All Rights Reserved.

### BACKGROUND

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game.

Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

Traditional gaming machines have incorporated a variety of displays to improve gameplay depiction, as well as provide signage on the gaming machine. However, displays in traditional mechanical reel gaming machines are limited given the static nature of the reel strips on each reel. One limitation with traditional mechanical reel slot machines is that in order for the gaming machine to be updated with a new or different game, the physical reel strips on the reels must be manually changed. Moreover, traditional displays such as LCD video displays and LEDS consume considerable quantities of power, particularly as gaming machine manufacturers strive to add more displays to increase the aesthetics and attraction of their products. Traditional displays also lack versatility due to their rigidity, viewing angle, and lower contrast.

### BRIEF DESCRIPTION OF THE DRAWINGS

FIG. 1 illustrates a perspective view of one gaming machine embodiment of the invention described herein.

FIG. 2 illustrates a cross-sectional view of an electrophoretic-based image display for use on gaming machines and other gaming-related devices.

FIG. 3 is a perspective view of an external structure of an electrophoretic image display, in a card or ticket used in gaming.

FIG. 4. is a cross-sectional view illustrating a recording medium embodiment for the electrophoretic image display for use on gaming machines and other gaming-related devices.

FIG. 5 is a block diagram illustrating an electrical structure of an electrophoretic image display for use on a gaming machine.

FIG. 6 is a block diagram of a control system suitable for operating the gaming machine of FIG. 1, including an electrophoretic image display associated with the gaming machine.

FIG. 7 illustrates electrophoretic images on a gaming machine video display.

FIG. 8 illustrates electrophoretic images on a gaming machine video display.

FIG. 9 illustrates electrophoretic images on a gaming machine video display.

FIG. 10 illustrates a change in electrophoretic images on a gaming machine video display.

FIG. 11 is a side view of a video display of a gaming machine that includes an electrophoretic image display.

FIG. 12 is a top view of a gaming table cloth that includes an electrophoretic image display.

### DETAILED DESCRIPTION

While this invention may be embodied in many different forms, there are shown in the drawings and will herein be described in detail a limited number of embodiments, with the understanding that the present disclosure is not intended to limit the universe of potential embodiments to the limited number that are illustrated.

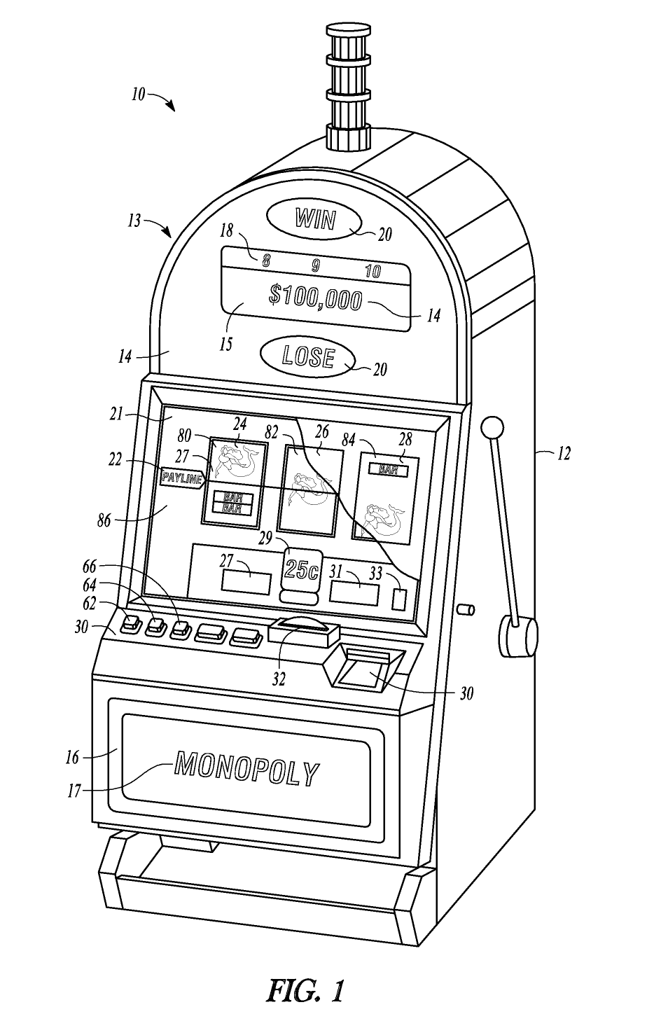

One gaming machine embodiment of the invention is illustrated generally at 10 in FIG. 1, includes a housing 12 with top box 13, top box glass 14, video display 21 with reel glass 86 and belly glass 16. For some embodiments, the top box 13 includes a pay table 18 and payout information 15 that may be displayed in part or in whole by one or more electrophoretic image displays. Some embodiments of the gaming device 10 also include at least one electrophoretic image display, such as is shown at 20, positioned on one or more of the components of the gaming machine 10, as is described herein.

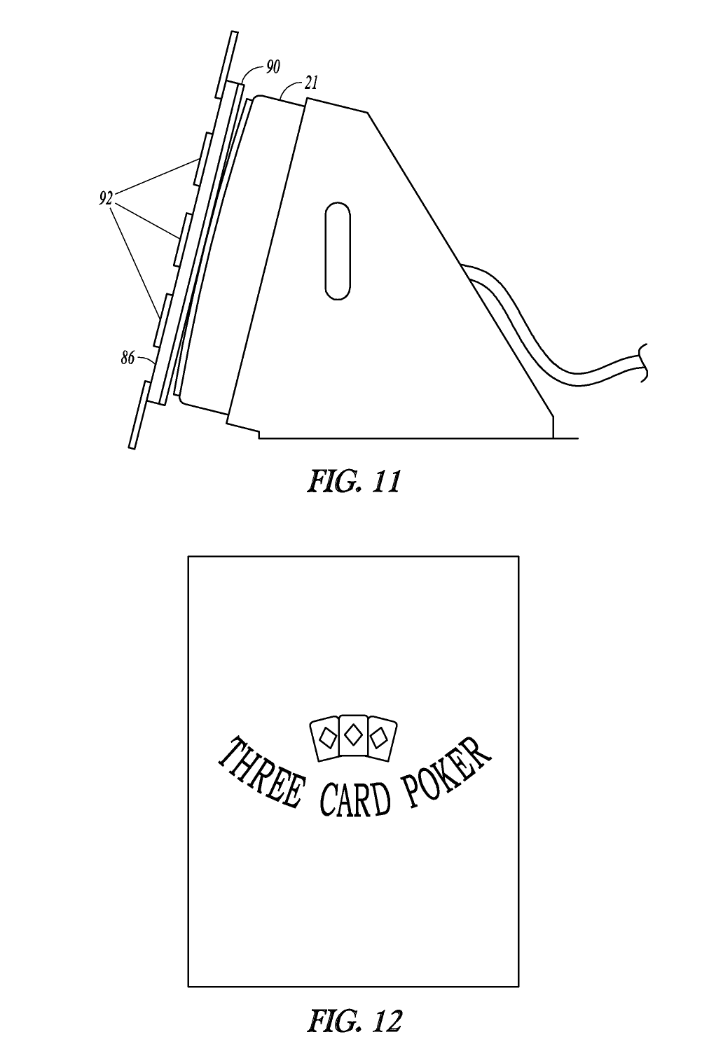

For one embodiment, one or more electrophoretic image displays 90 are positioned behind the reel glass 86, as is shown in FIG. 11. For another embodiment, one or more electrophoretic image displays 92 are positioned on an outer surface of the reel glass 86, as is shown in FIG. 11.

Electrophoretic image displays are usable to display virtually any type of image on a gaming machine or ancillary gaming device, such as a smart card or a ticket or gaming table or gaming table cloth. The electrophoretic images that may be displayed include static images as well as animated images. While electrophoretic image displays are available in monochrome, technology is expected to evolve that will enable the displays to display color. It is believed that colored electrophoretic image displays will be suitable for use in embodiments of the invention described herein.

Electrophoretic image displays present an exciting visualization of information for gaming machine players because of the detail, and, for some embodiments, unpredictability of the visualizations. The displays provide a tool for casinos to draw a gaming machine user and casino game player to a particular feature of a game. The displays also provide a manufacturer with an additional selling feature and enable a collection of gaming machines and gaming devices to project a common visual theme.

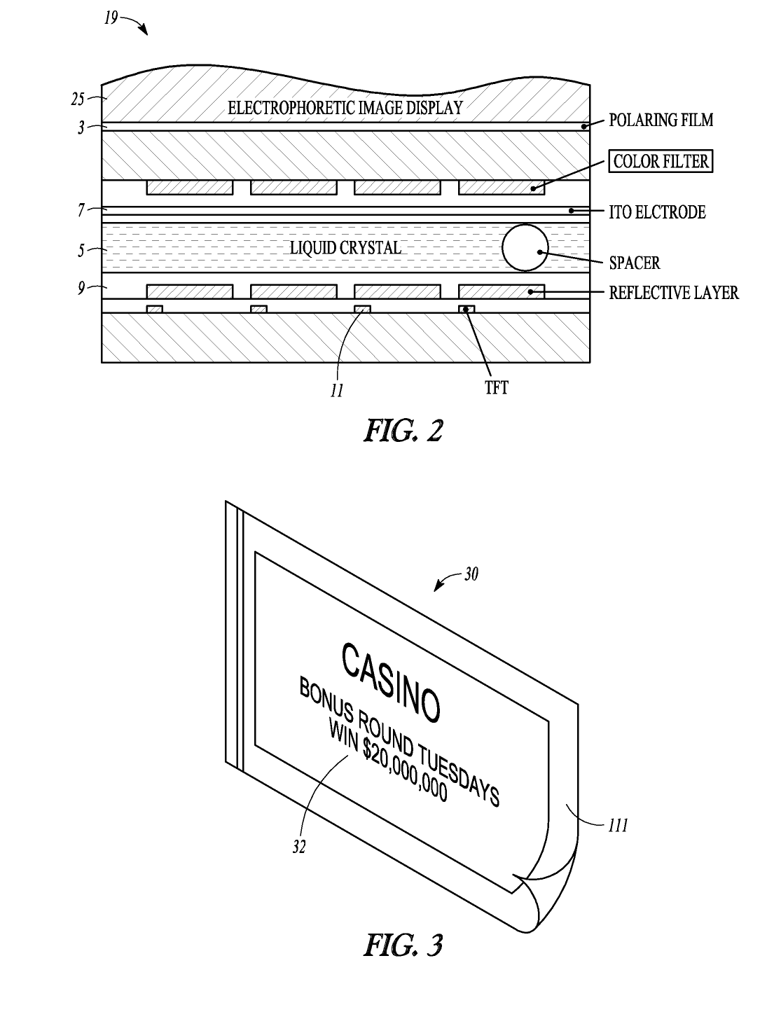

The electrophoretic image displays are combinable with other technologies such as transmissive liquid crystal display, hereinafter, LCD. The electrophoretic image displays are positionable behind a transmissive LCD to provide diffuse lighting for the LCD, as is illustrated for one LCD 19 in cross section, at 25 in FIG. 2. The LCD 19 also includes a polarizing film 3, liquid crystal 5, ITO electrode 7, reflective layer 9 and TFT 11. For some embodiments, the electrophoretic image displays may be positioned in front of a transmissive LCD to provide static or graphic images in conjunction with an LCD display.

The term, “electrophoretic image display” as used herein refers to a portable, reusable storage and display medium that looks like paper but may be configured to display indicia and may be refreshed many times. The term “electrophoretic image display” is also referred to herein as digital paper, “radio paper,” E-paper” or “electronic paper.” Electrophoretic image displays are capable of reversibly changing predetermined displays between visually recognizable states by the action of an electric field or other similar energy source. Electrophoretic image displays include, for some embodiments, ingrained images and decals overlayed on display media.

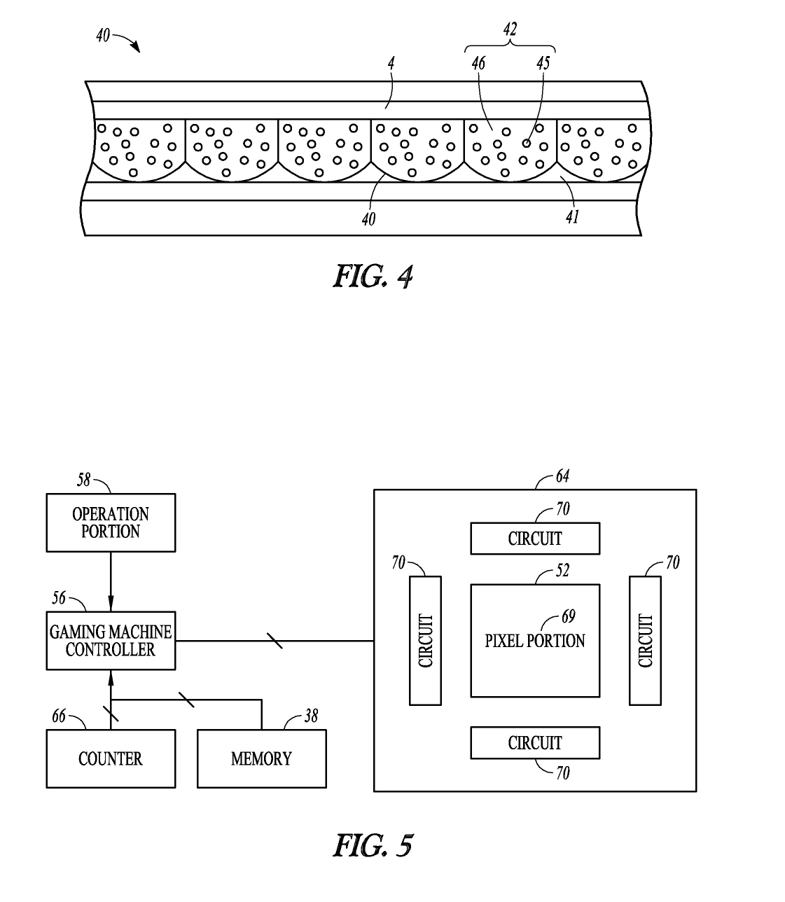

The electrophoretic image displays, illustrated as a card or ticket embodiment 30 in FIG. 3, include an electrophoretic display medium 32, a substrate 111, upon which the display medium 32 is positioned and a recording unit, illustrated for one embodiment at 40 in FIG. 4, wherein a recording unit generates images that are displayed on the display medium 32. One type of recording unit includes a substrate 46 and a plurality of tiny beads 45 dispersed over and embedded within the substrate 46. For some embodiments, each of the beads is two toned. For other embodiments, each bead is either black or white. For other embodiments, the beads are multi-toned. While beads are described herein, any electrophoretic medium is suitable for use in embodiments of the invention described herein.

When an electric field is applied to the substrate, the position of each of the beads is adjusted to create a pre-selected image. The two-toned beads rotate to display one of the colors. The black or white beads migrate in the electric field to form the image. The multi-toned beads also migrate to form an image. For some embodiments, the electrophoretic display medium includes a first substrate and a second substrate, at least one of which is transparent. For some embodiments, it is contemplated that one of the substrates will be colored. Other electrophoretic recording media are usable in various embodiments of the invention described herein.

The image display medium 32 has a flexibility that renders it usable on gaming machines, tickets 30, smart cards 30, playing cards, marketing literature, gaming table cloths and other image displays usable to attract gaming consumers and usable by gaming consumers. Other electrophoretic image displays are usable with cellular phones, and PDA's (Personal Digital Assistants), and any other hand held portable display.

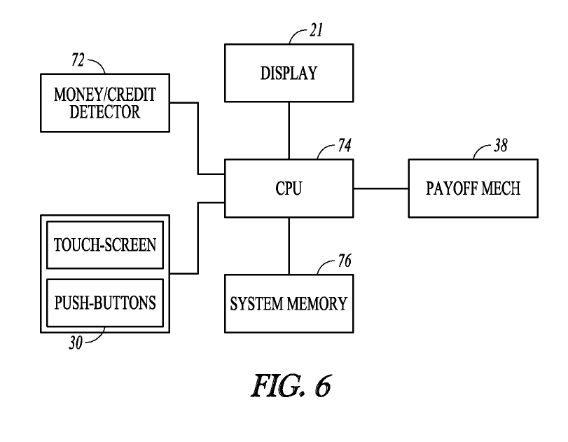

Some electrophoretic image display embodiments also include an electrode array, such as is shown at 70 in FIG. 5 for applying an electric field to the electrophoretic display medium according to image signals. These embodiments also have a mechanism for shifting the relative position of the display medium in an electric field in accordance with a pre-selected display. For these embodiments, a common electrode of the display medium is used as a ground potential. The electrode is made of an electroconductive thin film of a metal such as ITO, SnO2, or a mixture of ZnO and Al.

A block diagram of an electrophoretic image display for use on a gaming machine is illustrated generally at 50 in FIG. 5. The image display 52 generated by a recording unit, such as is shown at 42 in FIG. 4 is under control of a gaming machine controller 56. The gaming machine controller may be operated at 58 locally or through a server operating multiple gaming machines. The electrophoretic image display 52 also includes a memory 38 and a data reader for reading data in a memory medium such as CD-ROM and the like. The image display 52 includes a pixel portion 69, having a structure formed by the recording unit, shown at 42 in FIG. 4, and peripheral circuits 70 which are provided together with the pixel portion 69.

In an embodiment of the invention described herein, a portion of the exterior surface of the gaming machine housing 12 is overlayed with an electrophoretic display as is shown at 20 in FIG. 1. The electrophoretic display includes one or more panels with matrices of electrophoretic elements, one example of which is illustrated in FIG. 4. While the electrophoretic elements of FIG. 4 and FIG. 5 are shown, it is understood that other electrophoretic elements are suitable for use in various embodiments of the invention described herein.

The electrophoretic elements permit rapid and efficient change of graphical patterns that, for some embodiments, match a theme of the game played on the gaming machine. The graphical patterns impart a dynamic character to the gaming machine. The patterns generated by the electrophoretic displays are easily changed, thereby enabling rapid change in a theme of a network of gaming machines as well as a single machine. The change may be coordinated for multiple electrophoretic image displays on a single machine or multiple electrophoretic image displays on multiple machines or both.

For some embodiments, one or more electrophoretic displays are used to replace artwork associated with the top glass 14 and, for some embodiments, the belly glass 16. For some embodiments, the electrophoretic image display covers the entire housing 12 of the gaming machine, and for other embodiments, the electrophoretic image display covers one or more portions of the housing 12 in a form such as a decal, as is shown at 20, in FIG. 1.

For some embodiments, displays that are ancillary to displays on a gaming machine are generated by electrophoretic image displays. Images on these displays are, for some embodiments, coordinated with play on one or more gaming machines. The images may be animated or static and may be downloaded from an internal or external source. In one embodiment, a display is positioned so that a gaming machine player can view it. Images on the display are coordinated with play on the gaming machine to impart messages to the player and others in the vicinity of the gaming machine. The messages range from providing encouragement to the player, to congratulating the player, to providing a bonus or a bonus game for the player to play.

Some gaming machines include a reel module that includes one or more reels, reel glass and reel symbols displayed by electrophoretic images positioned on or adjacent to the reel glass. In one gaming machine embodiment, reel symbols 24, 26 and 28, in video display 21 are displayed by each of three electrophoretic images displaying reel symbols for each of three reels, namely, a first flexible display for reel 80, a second flexible display for reel 82, and a third flexible display for reel 84. The electrophoretic reel symbol images can be positioned on or adjacent to the reel glass 86.

With an electrophoretic image display, electrophoretic images on each of the flexible reel strips 80, 82 and 84 can be dynamically displayed. The dynamic attribute of each of the reel strip images is an animation of reel symbols for some embodiments. For other embodiments, the dynamic attribute is a rapid changeability. The rapid changeability enables the reel symbols to be changed during game play. The dynamic attribute enables new reel symbols to be downloaded to one or more of the digital paper-based reel strip from either a remote server or from a local computing device such as a laptop PDA or other computing device or other portable device. Thus, the digital paper enables downloadable gaming over mechanical reels. The digital paper is also usable on mechanical reel slots to display in-game meters that are currently displayed with LEDs attached behind the reel glass.

In response to a wager, the electrophoretic reel symbol images are rotated and are stopped to randomly associate symbols on the reels in visual association with at least one pay line 27. If a combination of symbols along the pay line 27 represents a winning combination, the player is awarded a payout identified on a pay table for that winning combination.

For some embodiments, the reel glass 86 is selectively transmissive to reveal the video reels 80, 82, and 84, credit meters 27, 31, and 33 and coin denomination 29 shown on the video display 12. Alternatively, instead of showing the credit meters 27, 31, and 33 and the coin denomination 29 on the video display, these items may be shown on electrophoretic image displays mounted between the flat video display panel 14 and the underlying electrophoretic image display. Such electrophoretic image displays assist in making a video gaming machine appear like a mechanical slot machine.

By displaying the reel symbols 24, 26 and 28 using electrophoretic image displays, the reel symbols are dynamic and changeable in accordance with the game being played on the gaming machine 10. The electrophoretic image display enables the reel symbols to be static or dynamic or both. The reel symbols may be re-cycled or may be new or modified. The reel symbols include one or more of animations, changing to wilds, changing to other symbols, nudgings, or other transformations based upon a random outcome or a spin outcome. The reel symbols of the embodiments described herein improve the game playing experience of a slot machine player by introducing an additional element of change and unpredictability to the gaming experience.

For other embodiments, reel symbols are changed during play of a game rather than during download. The changes include, for some embodiments, displaying additional symbols in conjunction with the mechanical reels, added, for instance, during a bonus round. If a player triggers a bonus round, such as in one example, five additional “wild symbols” may be added to the reel symbols temporarily during the bonus round. For other embodiments, symbol images may be eliminated from the gaming machine during play.

The new reel symbols may be downloaded to the electrophoretic image displays from a remote server, or local source within a gaming machine, or a local computing device such as a laptop, PDA and so forth. Thus, the electrophoretic image displays permit downloadable gaming over mechanical reels. For some embodiments, a game change in a gaming machine is performed by changing electrophoretic images on the gaming machine to comport to the new game. Images may be changed on or adjacent to the reel glass, buttons, keys, belly glass, top box glass and other gaming machine surfaces. This change is performed using conventional downloadable and local mechanisms.

The gaming machine 10 includes a plurality of push-buttons 62, 64 and 66 on a button panel 30 for operating the gaming machine 10. In addition, a touch screen, which is not shown, may be mounted by adhesive, tape, or the like over a front surface of the top box glass 14, belly glass 16 or reel glass 86. The touch screen contains soft touch keys denoted by electrophoretic image display graphics on an underlying flat panel and/or video display and used to operate the gaming machine 10. The touch keys may be used to implement the same functions as the push-buttons, as well as additional functions depending upon the level of player interaction demanded by the gaming game.

A player enables a desired function either by touching the touch screen at an appropriate touch key or by pressing an appropriate push-button on the button panel 30. Electrophoretic image displays are positionable on the push button panel 30, push buttons 62, 64 and 66, or touch keys and are usable to convey instructions for playing the gaming machine or encouragement to a player or other type of message. The electrophoretic images positioned on the buttons may be static or dynamic.

The images may be changed, for some embodiments, during game play. Each button may impart more than one message to the player. For other embodiments, the electrophoretic images positioned on the buttons are changed with a new game played on the gaming machine. In one example, a button displays a “spin” electrophoretic image at the beginning of a game and a “re-spin” in the middle of a spin of a game that permits a player to stop a spin in the middle of a spinning cycle after seeing the first symbol of the game. In another example for a multi-level game, buttons on a gaming machine dynamically change content at the beginning of a bonus round to allow for the buttons to be used for different functionalities during the bonus round—in the same manner button functionality changes when a shift key is pushed on a computer keyboard.

FIG. 6 illustrates a block diagram of a control system suitable for operating one or more electrophoretic image displays associated with one or more gaming machines 10. Money/credit detector 72 signals a central processing unit (CPU) 74 when a player has inserted money or played a number of credits. The money may be provided by coins, bills, tickets, coupons, cards, and other forms of chattel. Then, the CPU 74 operates to execute a game program that causes the electrophoretic image display paper on the video display 21 to depict three animated symbol-bearing reels. The player may select an amount to wager and start game play via the push-buttons 62, 64, and 66 or touch screen (if provided), causing the CPU 74 to set the reels in motion, randomly select a game outcome, and then stop the reels to display symbols corresponding to the pre-selected game outcome. One or more of the push buttons may also be overlayed with digital paper and display images as have been described herein.

In one embodiment, one of the basic game outcomes triggers a bonus game. Electrophoretic image displays may be changed in one or more locations on the gaming machine to conform to a bonus game theme. For some embodiments, electrophoretic images that are proximal to the gaming machine itself also display images that conform to the bonus game theme. For some embodiments, changes in electrophoretic image displays are made at the request of players and casinos. The changes in electrophoretic images may be for single displays or for a mass configuration.

A system memory 76 stores control software, operational instructions, and data associated with the gaming machine 10. In one embodiment, the system memory 76 comprises a separate read-only memory (ROM) and battery-backed random-access memory (RAM). However, it will be appreciated that the system memory 76 may be implemented on any of several alternative types of memory structures or may be implemented on a single memory structure. A payoff mechanism 38 is operable in response to instructions from the CPU 74 to award a payoff to the player in response to certain winning outcomes that might occur in the basic game or the bonus game. The payoff may be provided in the form of coins, bills, tickets, coupons, cards, etc. The payoff amounts are determined by one or more pay tables stored in the system memory 76.

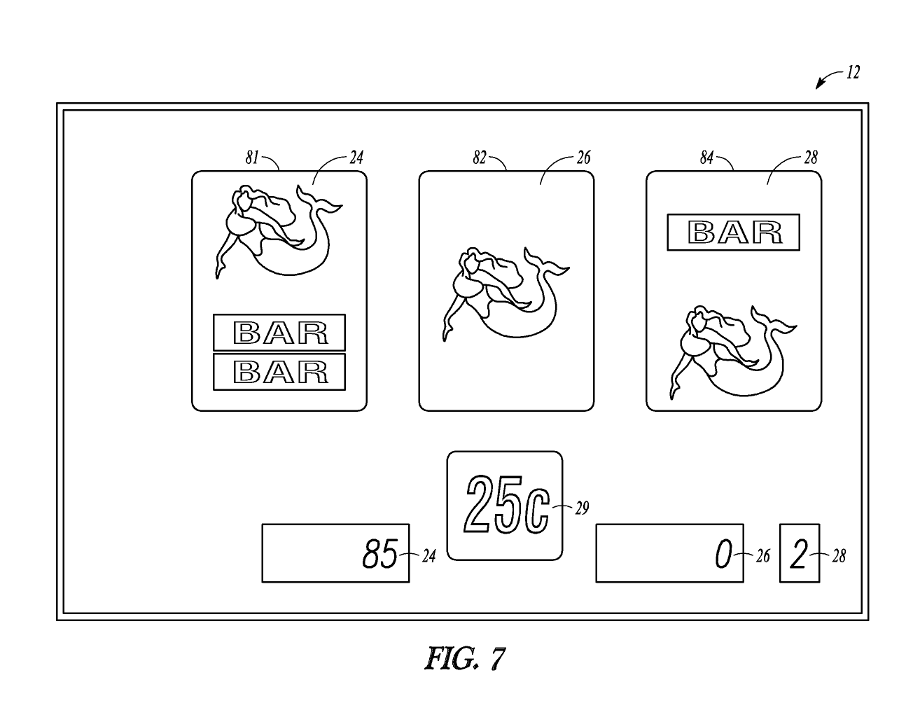

FIG. 7 is a front view of one embodiment of the video display 21. The video display 21 depicts the plurality of animated reels 80, 82 and 84 and reel symbols 24, 26 and 28, the numbers on the credit meters 27, 31, and 33, and the coin denomination 29 (e.g., 25 cents). The depictions shown in FIG. 7 are generated by electrophoretic image displays. Although three animated reels are illustrated, the number of animated reels may be varied, for example, to include one or more additional reels, by adjusting imagery on the electrophoretic image display. As discussed, electrophoretic images may be downloaded or changed during a course of a game. Electrophoretic image displays on the gaming machine may be coordinated with image displays ancillary to the gaming machine.

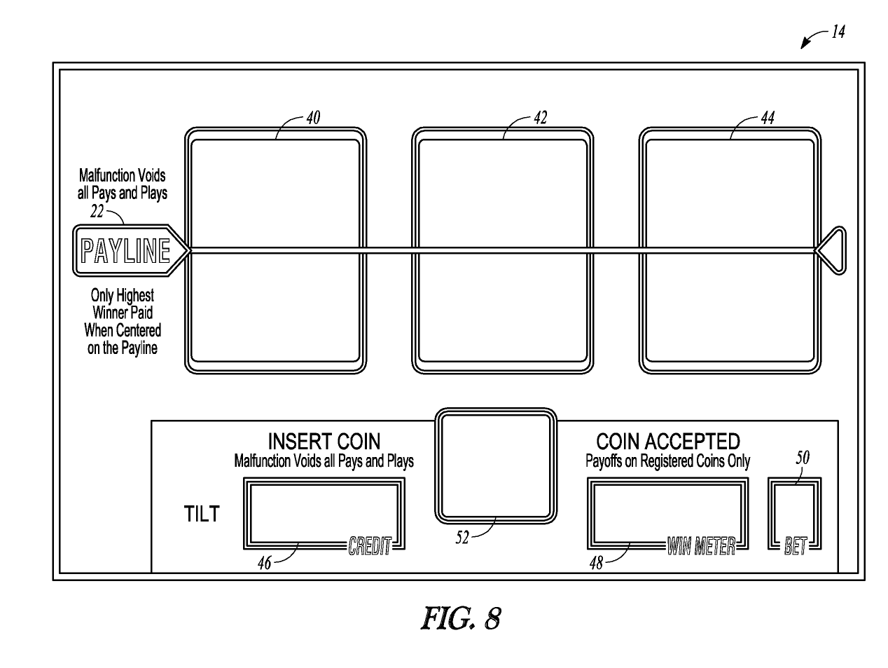

FIG. 8 is a front view of the reel glass 86 by itself, i.e., without a video display behind it. The reel glass 86 is composed of glass or plastic and is highly transmissive (i.e., transparent or translucent) of light in discrete areas to clearly reveal the electrophoretic image displays of video reels, credit meters, and coin denomination shown on the reel glass 86. Specifically, the reel glass 86 includes three large discrete transmissive windows 40, 42, and 44 for revealing electrophoretic image displays of the respective reels 80, 82 and 84, three smaller discrete transmissive windows 46, 48, and 50 for revealing the electrophoretic image displays of respective credit meters, and a discrete transmissive window 52 for revealing coin denomination. By isolating and revealing the electrophoretic image displays for animated reel symbols 24, 26, and 28 with the respective transmissive windows 40, 42, and 44 in the reel glass 86, the animated reel symbols 24, 26, and 28 are made to appear like they are part of mechanical reels. The various discrete transmissive windows are preferably solid portions of the video display panel 14, but may alternatively be openings or apertures in the reel glass 86.

In one embodiment, the remainder of the flat video display panel 14 is mostly non-transmissive, i.e., opaque, or substantially less transmissive than the discrete transmissive windows to emphasize graphics printed thereon and focus a player's attention toward the animated reels on the underlying video display. The graphics on the reel glass 86 are provided by an electrophoretic image display and show the pay line 22, miscellaneous textual information, instructions, trademarks, and credit meter labels. If there is more than one pay line, the pay lines may be successively highlighted as they are activated.

The reel glass 86 may utilize a number of different technologies to vary the optical transmissivity of different portions of the reel glass 86. In an embodiment, the reel glass 86 is permanently imprinted with non-transmissive or low transmissive material encompassing and forming the various transmissive windows using a digital imaging or screen printing process. In an alternative embodiment, the reel glass 86 itself is a transmissive liquid crystal display (LCD) of the type commercially available from L.G. Phillips LCD Co., Ltd. of Seoul, Korea. In another alternative embodiment, the reel glass 86 is a suspended particle device (SPD) of the type commercially available from Research Frontiers, Inc. A suspended particle device uses either a liquid suspension or a film within which droplets of liquid suspension are distributed. Light-absorbing microscopic particles are dispersed within the liquid suspension. The liquid suspension or film is then enclosed between two glass or plastic plates coated with a transparent conductive material. When an electrical voltage is applied to the suspension via the coatings, the particles are forced to align. This allows a range of transparency where light transmission can be rapidly varied to any degree desired depending upon the voltage applied. In a further alternative embodiment, the reel glass 86 includes polarizing layers in those areas where variation in optical transmissivity is desired. In another embodiment, an electrophoretic image display is positioned on the flat video display reel glass 86.

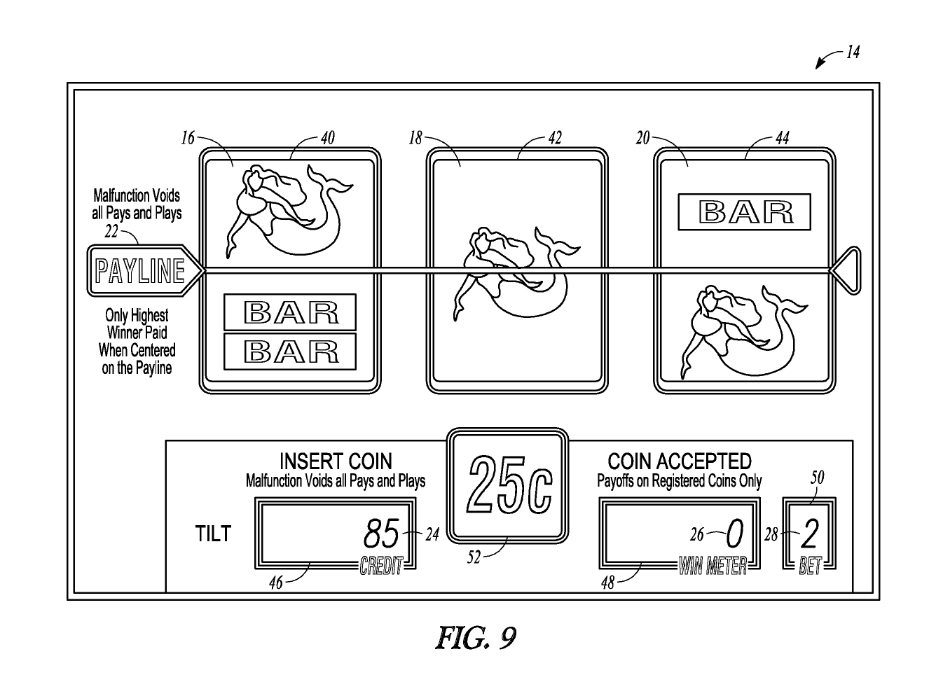

FIG. 9 illustrates a front view of the flat video display panel 14 mounted over an electrophoretic image display with the display depicting a basic slot game. The discrete transmissive windows 40, 42, and 44 on the flat video display panel 14 reveal electrophoretic image displays of the respective animated reel symbols 24, 26 and 28 on the video display. Another electrophoretic image displays the horizontal pay line 22 on the flat video display panel 14 which extends through a middle symbol on each of the reels. Although only the single pay line 22 is illustrated, the number of pay lines may be increased and may have various configurations other than a straight horizontal line. Another electrophoretic image display on the discrete transmissive windows 46, 48, and 50 reveal the respective credit meters on the video display. An electrophoretic image display on the discrete transmissive window 52 on the flat panel 14 reveals the coin denomination 29 (e.g., 25 cents) on the video display 12. As noted above, instead of showing the credit meters 24, 26, and 28 and the coin denomination 29 on the video display, these items may be shown on electrophoretic displays mounted behind the appropriate transmissive windows of the flat panel 14.

Referring to FIGS. 1 and 9, to initiate play on a gaming machine, a player inserts money provided by coins, bills, tickets, coupons, cards, etc. The “credit” meter 27 depicts a number of credits corresponding to the amount of inserted money. The player then chooses a number of credits to wager by pressing a “Bet” or “Max Bet” push-button on the button panel 30. For some gaming machine embodiments, an electrophoretic image display shows the “BET” meter which depicts the number of credits wagered for the most recent play of the slot machine. After placing a wager, the electrophoretic image display shows that animated reel symbols 24, 26 and 28 are set in motion by pressing a button with a “Spin Reels” electrophoretic display or pulling the handle 32. The CPU uses a random number generator to select a basic game outcome corresponding to a particular set of reel “stop positions.” The CPU then causes each of the animated reels to stop at the appropriate stop position. The electrophoretic image display shows reel symbols and reel stop positions and indicates whether the stop positions of the reels represent a winning outcome.

Winning outcomes such as symbol combinations resulting in payment of coins or credits, are identifiable to the player by a pay table. The pay table is provided by an electrophoretic image display on the top box glass 14 or belly glass 16. A winning outcome occurs when the symbols appearing on the stopped reels displays 80, 82, and 84 along the pay line display 27 correspond to one of the winning combinations on the pay table. A winning combination, for example, could be three matching symbols illustrated along the pay line 27 display. If the displayed symbols stop in a winning combination, the CPU credits the player an amount corresponding to the award in the pay table for that combination and number of credits wagered. The “win” or “paid” meter electrophoretic display depicts the number of awarded credits. The player collects an amount of money corresponding to any credits remaining on the “credit” meter by pressing a “Collect” push-button on the button panel 30. The “Collect” image is an electrophoretic display.

In one embodiment, some of the losing basic game outcomes are “near miss” outcomes. A “near miss” outcome occurs when a “winning” symbol combination is visible on the stopped reels but at least one of the symbols of the winning combination is not along the pay line 27 such that the symbol combination along the pay line 27 represents a losing outcome. The basic game outcome in FIG. 9 is a “near miss” outcome because the “winning” symbol combination of three MERMAID symbols is visible on the stopped reels but the MERMAID symbols on reels 16 and 20 are one position away from the pay line 27.

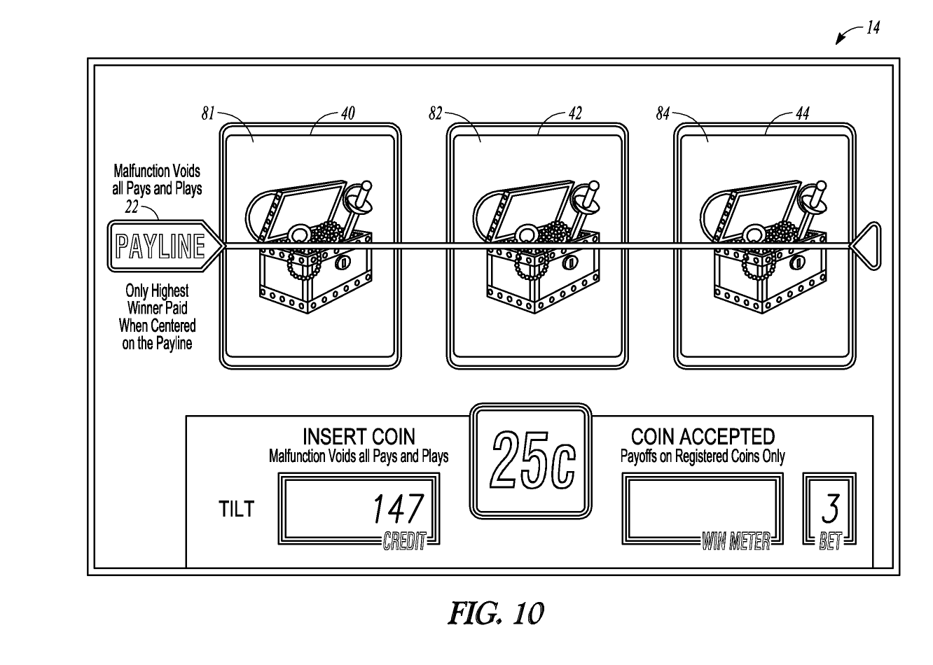

FIG. 10 is a front view of the flat panel video display 14 mounted over the electrophoretic image display depicts a bonus game. The bonus game is triggered by a start-bonus outcome in the basic slot game. The start-bonus outcome may, for example, be three MERMAID symbols along the pay line 22. Upon triggering the bonus game, the electrophoretic image display no longer depicts the animated reels behind the respective transmissive windows 40, 42, and 44. Rather, the electrophoretic image display is changed to display treasure chests of gold, silver and bronze with random coin amounts appear behind the respective windows. The treasure chests then hinge closed and swirl around. Using the push-buttons or touch screen (if provided), the player selects one of the treasure chests and is awarded the associated coin amount. Upon completion of the bonus game, the CPU shifts operation back to the basic slot game. In an alternative embodiment, the electrophoretic image display is dedicated to the basic slot game, and the bonus game is depicted on an electrophoretic image display mounted in the slot machine cabinet above the top glass 12 or the belly glass. In another embodiment, an image ancillary to the gaming machine displays images having a theme that conforms to the bonus game.

The gaming machine 10 offers a number of advantages. First, the gaming machine 10 looks like a mechanical slot machine and, therefore, would appeal to players of mechanical slot machines. As a result, the gaming machine 10 acts as a steppingstone from mechanical to video-based slot machines. Second, the gaming machine 10 offers games that are difficult or impossible to implement on mechanical slot machines. For example, the electrophoretic image displays depict first and second screen bonuses using animation that cannot be done on mechanical slot machines. Such bonuses can be interactive or non-interactive. Third, the gaming machine 10 facilitates modifications to the existing game or conversions to new games. For example, to modify a game to accept a different coin denomination as a minimum wager (e.g., 5 cent, 25 cent, $1, $2, and $5), the theoretical payback percentage of the game is modified. This is easily done without additional equipment by modifying the math tables in system memory and the distribution of reel symbols on the animated reels 24, 26 and 28, by changing the image programming of the electrophoretic image displays for the animated reels. If the machine 10 had mechanical reels, one would need to change the mechanical reels or at least the physical reel strips to reflect the modified payback percentage.

In one embodiment, the electrophoretic image display is used in conjunction with the top box glass 13 and the belly glass 16. In this embodiment, a first portion of the electrophoretic display is used for displaying a game of chance, a bonus game or any other gaming information that is typically displayed on the top box glass 13 and the belly glass 16. A second portion of the electrophoretic image display is used to display graphical patterns particular to the game of chance played on the gaming machine. This information includes game outcomes, meter information such as current jackpot value.

Logic used to generate the graphical patterns on the electrophoretic image display is stored in a memory device which is, for some embodiments, on the gaming machine. The game logic is executed by a gaming controller on the gaming machine. One or more controllers for the electrophoretic image display are used to generate the graphical patterns on the electrophoretic displays determined by the gaming controller. For other embodiments, the graphical patterns are downloadable to the electrophoretic image display from a remote server, such as a back-of-house server or a local computing device such as a laptop, PDA and other portable devices.

The gaming machine 10 in FIG. 1 is one example from a wide range of gaming machine designs on which various embodiments of the invention described herein is implemented. Suitable gaming machine embodiments include two or more gaming displays that are mechanical or video. Also included are electrophoretic image displays that are proximal to a gaming machine or that are viewable by a gaming machine user. The video display 21 in the top box may be a CRT, LCD, dot matrix, LED, electro-luminescent, or other type of video display known in the art. Those of ordinary skill in the art will understand that the embodiments described herein can be deployed on most any gaming machine now available or hereafter developed.

Electrophoretic image displays of various embodiments are also usable to provide player tracking services and game services. For some gaming machine embodiments, prior to beginning a game play session on the gaming machine 10, a player inserts a player tracking card 30 that includes an electrophoretic display into the card reader 24 to initiate a player tracking session. The electrophoretic display on the player tracking card is usable to display graphics for a game such as Monopoly, big fish, and other board games and card games. The player tracking card 30 is also usable for cashless gaming, carrying game assets among gaming machines, and transferring machine data from one machine to another, in addition to player tracking

Electrophoretic image displays are also usable to display information requested by or of interest to players, casinos and marketers.

A diagnostic electrophoretic display allows a game player, service technician or other game service representative to input information into the player tracking unit and receive player tracking status information. The diagnostic electrophoretic display utilizes a number of electrophoretic elements that display indicia that emphasize various information components to players and casino staff. The information includes but is not limited to, system and game communication status related to the status of the player tracking system, the gaming machine and peripheral equipment. For instance, drop/fill door open, jackpot pending, hopper empty and reel tilt signals may be conveyed as information in some format on the diagnostic electrophoretic display.

The electrophoretic elements may overlay or surround various player tracking interface devices. The thin electrophoretic interface displays may be manufactured with one or more cut-outs to allow the interface displays to surround one or more devices. For example, the electrophoretic display may surround a card reader 24 or a display. Further, one or more electrophoretic elements may be placed on top of one or more buttons on a key pad to illuminate each button.

The configuration and types of electrophoretic displays in a player tracking unit may vary from unit to unit. For example, some player tracking units may include a bonus button while other player tracking units may not include this feature. In another example, the input device may be configured in a stacked configuration such as a key pad, or card reader. Thus, the embodiments are not limited to one type of electrophoretic display configuration.

Electrophoretic displays are usable to indicate card 30 status information. Typically, a magnetic striped card is used to input player tracking information. The card must be inserted correctly to read the data. Card operation conditions are conveyed via electrophoretic display. For instance, an “invalid card” message, shown in a text format, may be displayed by an electrophoretic image display when an invalid card is inserted into the card reader and may remain on until the invalid card is removed. A graphical format such as a symbol, and a combination graphical format and textual format may be also used to indicate an invalid card. The card itself may contain an electrophoretic image display that conveys a message such as “invalid card.”

The electrophoretic image display of a “good luck” message, shown in a text format, may be off until a card is inserted and then may remain on for a fixed period of time and then be replaced with another message. For instance, the “good luck” message may remain on for 10 seconds after a card has been inserted and is replaced by a “card in service” message on the electrophoretic image display. An electrophoretic image display showing a “stranded card” message may be illuminated when a card has been inserted and the gaming machine has not been played for a preselected amount of time.

During game play, a player may desire to order a drink or obtain some other service from a casino service representative. When the player presses a drink button on a gaming machine, an electrophoretic image displays a drink message either on a location of the gaming system or on a display proximal to the player or proximal to a server, where it can be viewed by the server. For some embodiments, a player specifies a drink order using keys on the gaming machine and has a casino service representative deliver it. In other embodiments, a passing casino service representative views the drink messages on the electrophoretic display and takes a drink order from the game player. These messages may remain on until cleared by the service representative.

An electrophoretic display may display information regarding an amount won during a particular game play session, as shown at 15 in FIG. 1. The status information is indicated on the electrophoretic display 20. Additional status information may also be conveyed with electrophoretic displays of various embodiments. For instance, a player status such as valued customer status may be displayed on the electrophoretic display. As another example, other electrophoretic displays may be provided to display indicia for requesting different casino services such as a dinner or entertainment reservation. In yet another example, different electrophoretic displays may be illuminated to indicate printer status information, system control status and hopper status. Also, the electrophoretic displays may be arranged in different manners. The electrophoretic image display may be an animated display or a static display. The electrophoretic image displays may be used to display player tracking information, animations, bonus games, symbolic information, promotions, video frames and advertisements.

The text on buttons, one or more designs around the text, and the outline shape of the buttons may be generated using electrophoretic image displays. The text, design around the text and the outline shape of the buttons may all change with time by controlling the electrophoretic image elements in the matrix. For instance, the text may change styles and change colors over time. In yet another embodiment, animations and other patterns may be shown on the buttons.

Further, the position and size of the buttons may be varied by shifting the electrophoretic elements used to generate the button and by using more or less elements to generate the button. In another embodiment, a language used on the buttons, such as English, German, Japanese or French, may be selected by the player. Furthermore, the language displayed on some or all electrophoretic image displays on a gaming machine or array of gaming machines is changeable depending upon the gaming player's requirements.

In one embodiment of the present invention, different games of chance may be played on the same gaming machine. The games of chance may be selected by a player or an operator of the gaming machine. For each type of game of chance that may be played on the gaming machine, a unique game input interface display is generated with electrophoretic image displays on the machine.

Another embodiment of the invention includes a gaming table cloth, one embodiment of which is illustrated at 120 in FIG. 12. The gaming table cloth includes at least one electrophoretic image display 122. For some embodiments, the entire gaming table cloth is an electrophoretic image display with images that are changeable to accommodate changing from one game to another or to change visual features of one type of game. The gaming table cloth 120 facilitates the development of new table games because of the dynamic images displayed. By dynamic is meant that the images may be animated for some embodiments and changeable.

Yet another embodiment of the invention includes an electrophoretic image display of cards. In one embodiment, the electrophoretic image display includes a deck of cards, wherein each card is an electrophoretic image display. Instead of dealing cards, the images on cards in a player's hand are changed for each game played.

Although the foregoing embodiments have been described in some detail for purposes of clarity of understanding, it will be apparent that certain changes and modifications may be practiced within the scope of the appended claims. For instance, while the gaming machines illustrated herein have been depicted as upright models having top box mounted on top of the main gaming machine cabinet, the use of gaming devices in accordance with various embodiments is not to be so limited. For example, a gaming machine may be provided without a top box or the gaming machine may be of a slant-top or a table top design.

The Abstract of the Disclosure is provided to comply with 37 C.F.R. §1.72 (b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Thus, this Detailed Description is meant to be illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

What is claimed is:

1. A gaming machine, comprising:
a value input device for receiving a wager;
a housing attached to the value input device;
at least one rotatable reel attached to the housing, the reel comprising a reel strip arranged about a periphery of a cage; and
a controller attached to the housing and operatively coupled to an input device to alter appearance of a first part of an electrophoretic image display attached to at least one of a player tracking card or a credit ticket that can be read by the input device.

2. The gaming machine of claim 1, wherein a second part of the electrophoretic image display is positioned on the housing.

3. The gaming machine of claim 1, wherein a second part of the electrophoretic image display is positioned on at least one button supported by the housing.

4. The gaming machine of claim 1, wherein the controller is operative to download a first image and a second image from one or more external systems, wherein the controller is operative to configure the electrophoretic image display to selectively display the first image and/or the second image.

5. The gaming machine of claim 4, wherein the first image is associated with a first theme of the gaming machine and the second image is associated with a second theme of the gaming machine

6. The gaming machine of claim 1, wherein the reel strip comprises:
a second part of the electrophoretic image display.

7. An apparatus, comprising:
a gaming machine player tracking card; and
an electrophoretic image display attached to the card, wherein an image displayed by the electrophoretic image display is alterable by a gaming machine input device configured to accept insertion of the card.

8. The apparatus of claim 7, wherein the electrophoretic image display is alterable to display graphics for a game.

9. The apparatus of claim 7, wherein the electrophoretic image display is alterable to display status of the card.

10. The apparatus of claim 7, wherein the electrophoretic image display is alterable to display status of a gaming machine or gaming machine peripheral equipment.

11. The apparatus of claim 7, wherein the electrophoretic image display is alterable to display status of information tracked by the tracking card after the insertion.

12. The apparatus of claim 7, wherein the card includes a memory comprising a magnetic stripe to store player tracking information.

13. The apparatus of claim 7, wherein the card includes a memory to store game assets and/or machine data.

14. An apparatus, comprising:
a gaming machine credit ticket; and
an electrophoretic image display attached to the ticket, wherein the electrophoretic film is alterable by a gaming machine input device configured to accept insertion of the ticket.

15. The apparatus of claim 14, wherein the electrophoretic image display is alterable to display an animated image.

16. The apparatus of claim 14, wherein the electrophoretic image display is alterable to display a player payoff amount.

17. The apparatus of claim 14, wherein the electrophoretic image display is alterable to display a player credit amount.

18. The apparatus of claim 14, wherein the electrophoretic image display is alterable to display information requested by a player.
